(19) United States
(12) Patent Application Publication
(10) Pub. No.: US 2011/0291801 A1
(43) Pub. Date: Dec. 1, 2011

(54) PERSONAL WARNING DEVICE

(76) Inventors: WILLIAM R. SOMMER, Mequon, WI (US); Ruth Sommer, Mequon, WI (US)

(21) Appl. No.: 13/150,922

(22) Filed: Jun. 1, 2011

Related U.S. Application Data
(60) Provisional application No. 61/396,619, filed on Jun. 1, 2010.

(51) Int. Cl. G08B 5/22; G10L 11/00

(52) U.S. Cl. 340/8.1; 340/6.1; 704/275; 704/E11.001

(57) ABSTRACT

A personal warning device for preventing or stopping attacks on individuals by persons or animals. The device may be manually activated or may be activated by voice recognition. The device may be programmed to recognize a specific user's voice and may be reused and programmed by multiple users. The device may be attached to the personal effects of the user or may be carried.

### RELATED APPLICATIONS

This application claims the benefit of U.S. Provisional Application Ser. No. 61/396,619 filed 1 Jun. 2010.

### BACKGROUND OF THE INVENTION

The present invention relates particularly to alarm apparatuses, particularly to personal alarm devices meant to be carried on or by the person using it. The device may be triggered to sound an alarm in the event of an attack or other danger.

Many different conventional alarms exist, including large automotive alarms and building alarms. Such alarm systems are typically large in size and are not intended to be used as portable, personal warning alarms. Because they are permanently mounted to the vehicle, automotive alarm systems cannot be transported by the user to remote locations. Further, certain automotive alarms that may include personal warning features are generally only effective if the user is in close proximity to the vehicle and must be activated by push-button only.

Other forms of personal trouble warning alarms such as alarms mounted in covered parking garages, are not intended to be used as mobile or portable, hand-held personal trouble warning alarms since these systems are permanently affixed to a building structure or in a covered parking garage and are only effective in that particular parking garage.

Other personal trouble warning alarms exist, some of which are typically referred to as “air horns”. This type of device is usually activated by either a pull-cord or push-button. Due to size, these devices are only marginally mobile or portable and therefore are not suitable for practicable transport on ones person, such a key-chain, in a purse or in a clothing pocket.

Smaller, personal alarms are also known, such as those intended to be carried or worn on the individual, and may emit a warning, when activated by a variety of means, including sound or motion. However, many of these conventional mobile or portable hand-held personal trouble warning alarms are complicated or difficult to use under certain circumstances. Difficulty in activation may arise especially when the user is in acute distress, as when the alarm is needed to ward-off an attack by a person or animal.

Thus there exists a need for an easy to use, portable personal warning device that may be activated by the user while in difficult situations, such as when in acute distress. Further needed is a device that while being simple to activate is also easily but accessibly carried by the user, all while having a commercially appealing outward appearance.

### SUMMARY OF THE INVENTION

A primary objective of the present invention is to solve the problems of the prior art.

Another object is to provide a sound signal generating device which is capable of generating an alarm sound.

A further object of the present invention is to provide a sound signal generating device which is capable of being activated through voice recognition.

A still further object of the present invention is to provide a sound signal generating device which is capable of recognizing and being activated by multiple user voices.

The present invention is an improved mobile and portable personal trouble warning device which emits a high decibel warning alarm when activated. The device is activated by a push-button or by a programmable, multi-voice command system.

### BRIEF DESCRIPTION OF THE DRAWINGS

FIG. 1 is a perspective view of an embodiment of a personal warning device.

FIG. 2 is a front view of the device shown in FIG. 1.

FIG. 3 is a side view of the device shown in FIGS. 1 and 2.

FIG. 4 is a back view of the device shown in FIGS. 1-3.

FIG. 5 is a partially exploded view of the device shown in FIGS. 1-4, and including a block diagram of included components.

FIG. 6 is an illustrative flow chart describing programming of the present invention.

FIG. 7 illustrates voice activated use of the present invention, with the device attached to a hand bag.

FIG. 8 is a view illustrating manual activation of the present invention.

FIG. 9A illustrates a use of the present invention as attached to a backpack.

FIG. 9B illustrates a use of the present invention as attached to a handbag.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

Referring now to the Figures, it may be seen that a personal warning device according to the present invention may be constructed of any suitable, commercially appealing form, including the owl form shown. It is to be understood that while an owl form is shown in the Figures, any suitably sized and commercially attractive format may be used. A personal warning device according to the present invention may be made from any suitable material such as molded plastic or of any other sufficiently rigid and strong material such as high-strength plastic or resin, metal, and the like.

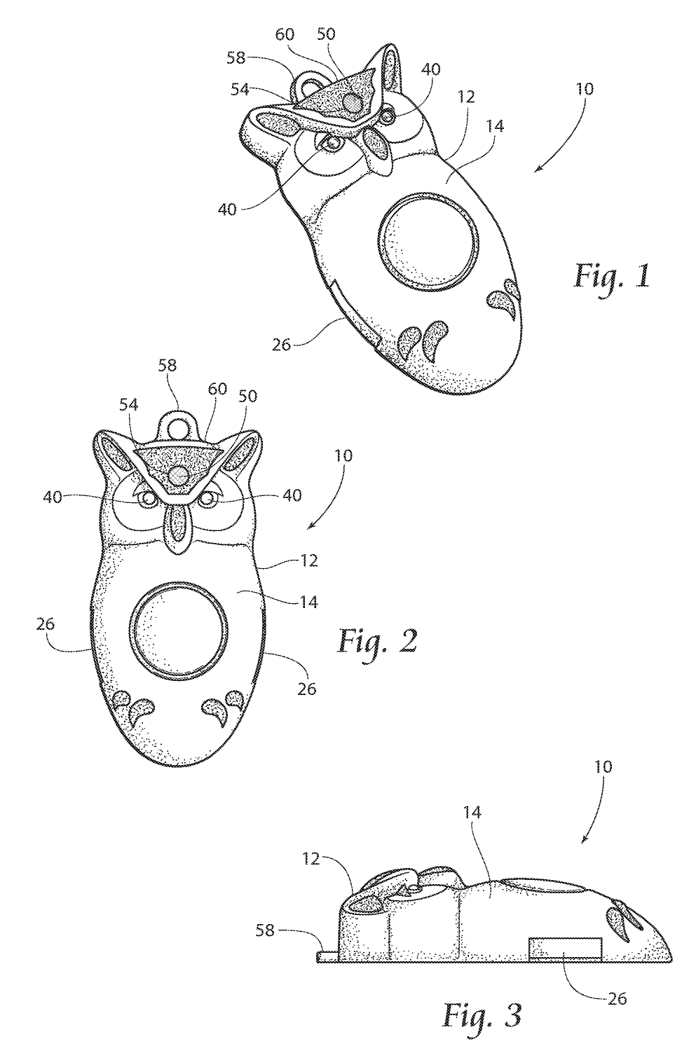

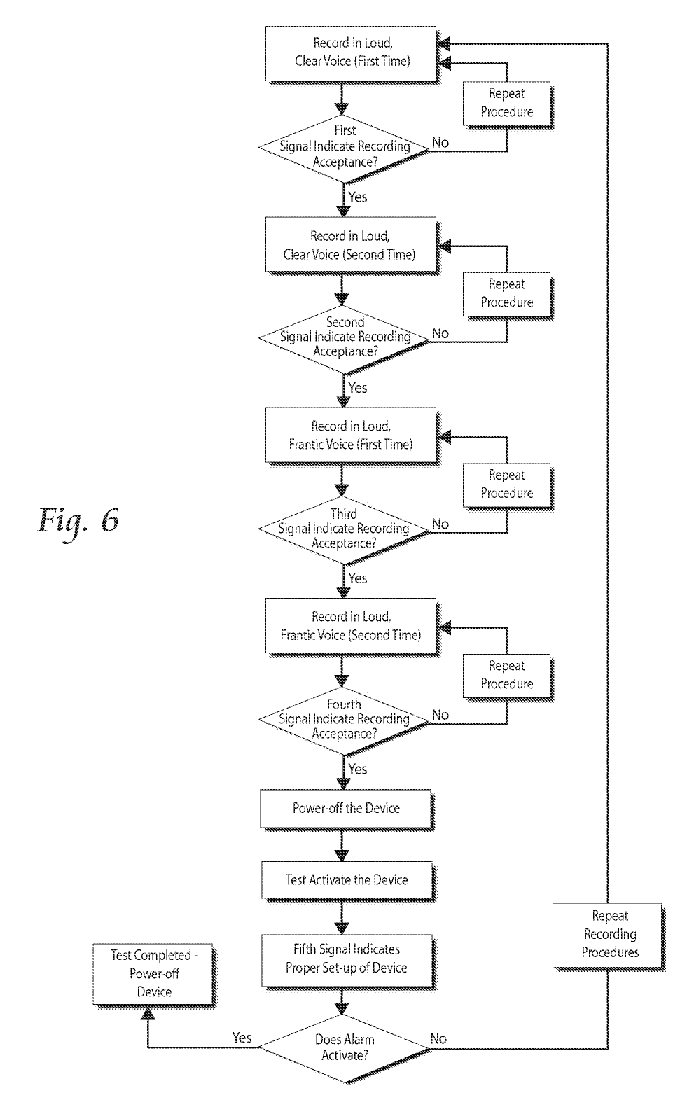

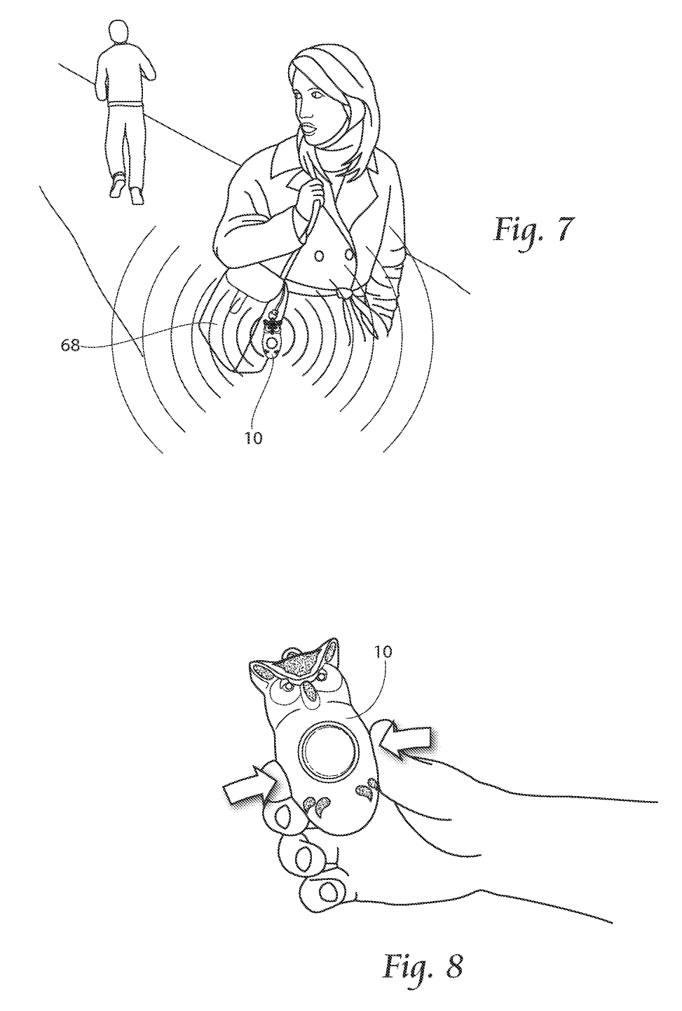

With specific reference to FIGS. 1-5, a device according to the present invention is generally designated by the reference numeral 10. As shown, the device 10 generally includes a housing 12 having a front surface 14, which may be ornamental in appearance, and a back surface 16, which may include access to an internal cavity 18. As seen particularly in FIG. 5, the device 10 preferably includes a power source 20, such as a rechargeable battery, which supplies power to a central processer 22. The central processer 22 is used to control and activate the components of the device 10, as will be discussed in detail.

A speaker 24 is used to transmit an audio alarm signal outward from the device 10 to thereby ward away attackers and to attract assistance. It is to be understood that the exact position of the speaker 24 may vary according to the specific product configuration; however, a suitable position will be one that allows for transmission of an audible alarm signal when activated. It is contemplated that a suitable audio alarm signal may include an ultra high decibel signal, such as for example a 120 decibel alert, capable of being heard at distances and startling would-be attackers. The device 10 may further include at least one manual activation button 26.

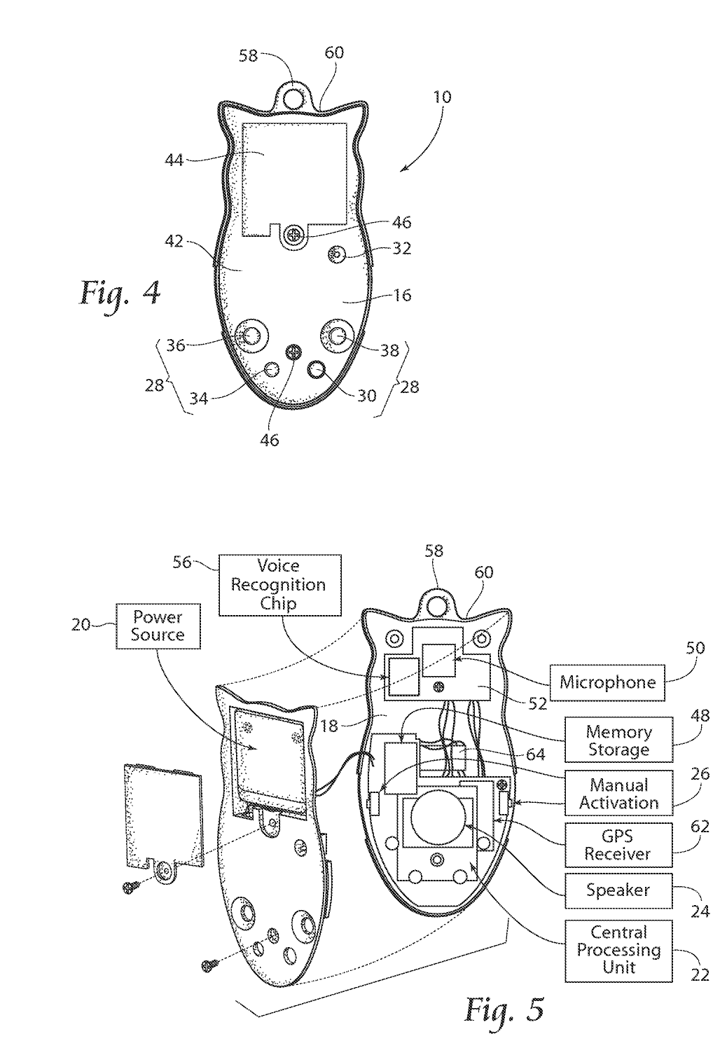

Referring now to FIG. 4, there is shown a back view of device 10 which, as is also depicted in FIG. 3, is relatively flat in shape although the perimeter profile may depict an ornamental shape such as the owl shown. As illustrated, the back surface 16 of the device 10 may include a series of activators 28, such as the push buttons shown. The activators 28 may be used to perform various functions of the device 10, such as power on/off, or to assist in the voice recognition programming procedure (see FIG. 6). As may be further seen, the back surface 16 may also include other device 10 features, such as a reset button 30, means for recharging the power source 20, such as the AC plug adaptor 32 depicted, along with an indicator light 34 to indicate whether the power source 20 is fully charged or needs charging. Further included may be a power on/off button 36 having an audible signal to indicate that the device 10 is in the on orientation and visual indicators 40 (see FIGS. 1 and 2) to indicate to the user that the device 10 is powered on, along with a memory record button 38 or other features as may be desired. It is to be understood that while the mentioned features are depicted on the back surface 16 of the device 10, any of them may be relocated without departure from the present invention. Access to the internal cavity 18 (see FIG. 5) may be gained through use of the rear cover plate 42 shown. Additionally, access to the power source 20 (see Figure 5) may be gained through use of the battery cover plate 44 shown. As illustrated, fastening members 46, such as the conventional screws illustrated, allow facile removal of the rear cover plates 42 and 44 to thereby access the internal electronics or internal cavity 18 and battery 20, respectively, if desired.

As is further illustrated in the view of FIG. 5, the device 10 is shown to include a memory storage 48 for storing a user-selected personal alarm word received via a microphone 50, or other pick-up device, a power source 20, such as a rechargeable battery to supply power to a central processor 22, internal circuitry 52, speaker 24, microphone 50, and the visual light indicators 34 and 40 (see FIGS. 1 and 2). As mentioned above, at least one speaker 24 is used to transmit audio signals outward from the device 10 and for use to give audible signals to the user regarding device 10 status. The device 10 further preferably includes at least one microphone or other pick up device 50 to receive voice signals by the user and to aid in voice recognition programming prior to use. The microphone 50 illustrated in the Figures is preferably positioned within the housing 12 such that it is audibly accessible through an opening 54 (see FIGS. 1 and 2) or other acceptable manner. Further included is a sensory voice recognition chip 56 for facilitating voice recognition programming and to prevent the device 10 from alarm activation by another voice or during casual conversation.

The device 10 is initially programmed using the method depicted in the FIG. 6 flowchart. The device 10 is programmed by the user to be activated by a user-selected personal alarm word. As shown in FIG. 6, the method of programming includes the steps of:

pressing and holding a first memory activator 38;

receiving a signal indicating device 10 is ready;

inputting the selected personal alarm word into the device 10, by stating the word into the microphone 50;

receiving a signal indicating word has or has not been accepted by the device 10, if signal indicates non-acceptance, repeat from start, if signal indicates acceptance pressing the first memory activator 38;

inputting the selected personal alarm word into the device 10 a second time;

receiving a signal indicating word has or has not been accepted by the device 10, if signal indicates non-acceptance, repeat from start, if signal indicates acceptance pressing the first memory activator 38;

inputting the selected personal alarm word into the device 10 in a loud emergency manner;

receiving a signal indicating word has or has not been accepted by the device 10, if signal indicates non-acceptance, repeat from start, if signal indicates acceptance pressing the first memory activator 38;

inputting the selected personal alarm word into the device 10 in a loud emergency manner a second time;

receiving a signal indicating word has or has not been accepted by the device 10, if signal indicates non-acceptance, repeat from start, if signal indicates acceptance pressing the on/off actuator 36; receiving a signal indicating power down is complete;

pressing the power on/off actuator 36;

receiving a signal indicating activation is complete and device 10 is ready for use.

Additionally, multiple users may record and save their voices in the memory storage 48 of the device 10. This capability makes the device 10 more versatile and accommodating for use by families or groups.

The device 10 further may include visual light indicators 40, seen as the eyes of the owl in the views of FIGS. 1 and 2. The visual light indicators 40 may be light emitting diodes, or any other compact light emitter, and used to provide device status signals to the user. For example, a first signal indicates that the first step of voice recording is complete; a second signal indicates that the voice recording is complete; a third signal indicates that the device 10 is activated and ready for use; a fourth signal indicates that the power source 20 needs charging or replacement; a fifth signal indicates that the voice recording procedure has failed and must be restarted. The various visual light indication signals provide facile delivery of device status to the user. Alternatively, the device 10 may provide status indication by way of audible signals through the speaker 24.

Activation of the device 10 occurs upon either a verbal or a manual cue by the user. To activate the device 10 verbally, the user states the selected personal alarm word, which at this step is referred to as the activation word. The activation word must be stated loud enough so that the microphone 50 can pick it up. The activation word is processed by the central processing unit 22 and the voice recognition chip 56 to determine if the activation word is a known, stored personal alarm word and if it is being stated by a stored user in a loud emergency manner. If so, an audible alarm from the speaker 24 will sound. If one of these requirements is not met, the alarm will not sound. Therefore, false alarms are prevented when the user states the activation word in a normal conversation; the user states a different word in an emergency manner; or if a person, other than a user, states the activation word in an emergency manner. Furthermore, to activate the alarm manually, the user may simply press a manual activation button 26. Additionally, the visual indicators 40 may turn on during alarm activation for further signaling of user distress.

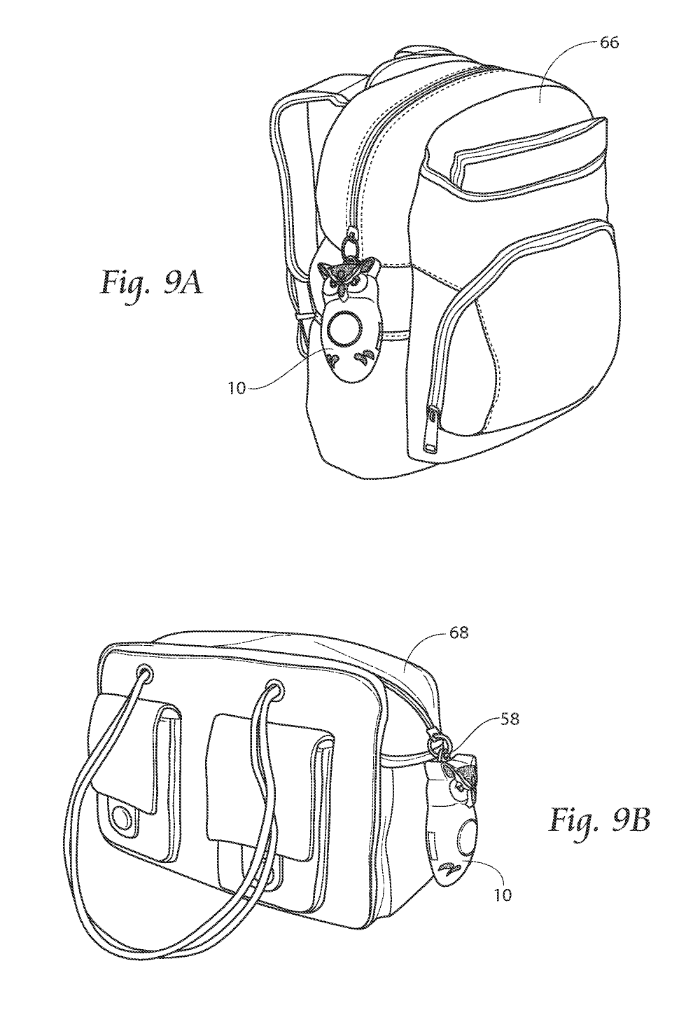

The device 10 may further include attachment means, such as the loop member 58 illustrated on the top 60 of the device 10 shown in these views. A loop member 58 may be used to temporarily or permanently affix the device 10 to a duffel bag 66 or purse 68, as seen in the views of FIGS. 9A and 9B, respectively. A user of the device 10 may contemplate endless uses for the loop 58, such as use on a keychain, by way of non-limiting illustration. Alternatively, the device 10 may be carried by hand due to its relatively small and lightweight characteristics.

An alternative embodiment of the device 10 may further include a Global Positioning System (“GPS”) receiver 62. A GPS receiver 62 may relay position or other relevant data to another similar device, cellular phone, emergency call center, or other electronic device capable of receiving information (not shown) via wireless broadband, Bluetooth®, radio frequency, or other transmission facilitator (not shown). The GPS data is transmitted via a signal transmitter 64 when the device 10 is activated either by verbal or manual activation. Although a display is not depicted in the embodiment shown, other embodiments may include this feature to display the current position, time, or other relevant information to the user. Furthermore, the GPS receiver 62 adds another safety feature for use in situations in which the user is lost or unable to move to safety.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/we claim:

1. A personal warning device including:
a housing having a front surface, a back surface, and a cavity;
a power supply for providing the device with power;
a speaker located within the housing cavity and positioned for sounding an audible alarm from said device
a microphone located within the housing cavity and positioned in an opening in a surface of the housing for receiving audio transmission from a user;
at least one actuator located on a surface of the housing;
at least one visual light indicator located within the housing cavity and viewable through a surface of the housing;
a memory storage device located within the housing cavity;
a central processing unit located within the housing for processing input data from the microphone and the actuator, and outputting data to activate the visual light indicator and audible alarm; and
wherein the memory storage device is in operable communication with the central processing unit to store input data.

2. The personal warning device of claim 1 wherein said at least one visual light indicator is a light emitting diode.

3. The personal warning device of claim 1 wherein said power source is a rechargeable battery.

4. The personal warning device of claim 1 further including a GPS receiver and a signal transmitter, wherein said central processing unit is capable of processing data from said GPS receiver and outputting said data with said signal transmitter.

5. A method for using a personal warning device including the steps of:
providing a device having a power supply for providing the device with power, a speaker positioned for sounding an audible alarm from said device, a microphone positioned for receiving audio transmission from a user, at least one actuator, at least one visual light indicator, a memory storage device, a central processing unit for processing input data from the microphone and the activator, and outputting data to activate the visual light indicator and the audible alarm, wherein the memory storage device is in operable communication with the central processing unit to store input data;
inputting a personal alarm word into said microphone for storage in said memory storage device;
inputting an activation word into said microphone;
comparing the personal alarm word stored in the memory storage device with the activation word;
verifying the activation word voice and word; and
activating said audible alarm.

6. The method of claim 5 wherein the step of activating said audible alarm includes activating said at least one actuator.

7. The method of claim 5 further including the steps of: providing a GPS receiver and a signal transmitter; and
whereby inputting the activation word into said microphone activates said GPS and said signal transmitter.

8. The method of claim 5 further including the steps of: providing a GPS receiver and a signal transmitter; and
inputting a manual input signal into said at least one actuator to thereby activate said GPS and said signal transmitter.
